(19) United States
(12) Patent Application Publication
(10) Pub. No.: US 2010/0015291 A1
(43) Pub. Date: Jan. 21, 2010

(54) DOUBLE-FORTIFIED SALT AND PREPARATION PROCESS THEREFOR

(75) Inventors: Justus Marie De Jong, Borne (NL); Gerrit Jan Stokkers, Bathmen (NL)

Correspondence Address: KENYON & KENYON LLP, ONE BROADWAY, NEW YORK, NY, 10004, US

(73) Assignee: AKZO NOBEL N.V., ARNHEM (NL)

(21) Appl. No.: 12/293,853

(22) PCT Filed: Mar. 16, 2007
(86) PCT No.: PCT/EP07/52484

§ 371 Date: Oct. 22, 2008

Related U.S. Application Data
(60) Provisional application No. 60/791,442, filed on Apr. 13, 2006.

(30) Foreign Application Priority Data
Mar. 21, 2006 (EP) 06111433.6

(51) Int. Cl. A23L 1/237; A23L 1/304; A23L 1/22

(52) U.S. Cl. 426/74; 426/649

(57) ABSTRACT

The present invention relates to a double-fortified salt composition comprising sodium chloride, between 5 and 100 ppm of iodine in the form of iodate, between 50 and 10,000 ppm of iron as a food-grade iron(III) compound, and between 0.005 and 0.2 wt %, based on the totat weight of the salt composition, of one or more food-grade oils, with the proviso that essentially all iron and iodate is not micro-enicapsulated, to a premix therefor, to a process for preparing such a double-fortified salt composition and premix, and to the use thereof.

The present invention relates to a double-fortified salt composition, to a premix therefor, to a process for preparing such a double-fortified salt composition and premix, and to the use of double-fortified salt compositions.

Iodine deficiency is a major public health problem for populations throughout the world, particularly for pregnant women and young children. Iodine deficiency causes several serious health problems that can lead to disabling and/or retarded development and to the onset of a variety of diseases. The main factor responsible for iodine deficiency is a low dietary supply of iodine. It occurs in populations living in areas where the soil has a low iodine content as a result of past glaciations or the repeated leaching effects of snow, water, and heavy rainfall. Crops grown in this soil, therefore, do not provide adequate amounts of iodine when consumed. The general strategy for the control of iodine deficiency disorders is correcting the deficiency by increasing the iodine intake through food fortification.

Fortification of foods is a food-based approach which has been used effectively to control micronutrient malnutrition in many developed countries. It is increasingly used in developing countries too, as it is recognized as a cost effective strategy for wider coverage of the population The choice of a proper vehicle is a key to the effectiveness of fortification programs. A wide variety of vehicles such as salt, sugar, cereal flours, and grain have been successfully utilized in the fortification programs of many countries.

Because of its widespread and gradual consumption, food-grade salt is a perfect vehicle for iodine fortification in many countries. Furthermore, it is safe, sustainable, and inexpensive. In the past decades this iodine-fortified salt, wherein the iodine is present as iodide (I⁻) or iodate (IO₃⁻), has been successfully introduced across the globe.

Iron deficiency anemia (IDA) is another widespread nutritional disorder, especially in developing countries. According to the World Health Organization, as many as 80% of the world's population may be iron deficient, while 30% may have iron deficiency anemia. Severe anemia during pregnancy is associated with increased risk of maternal mortality, premature delivery, and low birth weight. Iron deficiency anemia can impair intellectual development and immune response in children and limit their capacity for physical activity. One of the practical ways of controlling IDA is to provide iron through the fortification of widely consumed dietary items, and preferably as iron-fortified salt (IFS).

However, since the problems of iron deficiency anemia and iodine deficiency disorders often coexist, it is preferred to control iron deficiency and iodine deficiency disorders simultaneously by means of a single food fortification concept. This concept has stimulated efforts to develop a technology for the double fortification of salt, one of the most suitable vehicles, with both iodine and iron.

Over the past decade there have been many unsuccessful attempts to provide such an iron and iodine-fortified common salt (also denoted as double-fortified salt—DFS), because a major technical problem in the development of DFS is the instability of iodide compounds in the presence of iron. Due to the oxidation/reduction reactions indicated below as Equations 1, 2, and 3, elemental iodine will be produced, which will then evaporate from the fortified salt.

Fe²⁺⇄Fe³⁺+e⁻ Eq. 1

For iodide:

2Fe³⁺+2I⁻→2Fe²⁺+I₂(brown gas) Eq. 2

For iodate:

IO₃⁻+6H⁺+6Fe²⁺→I⁻+3H₂O+6Fe³⁺ Eq. 3

I⁻ and Fe³⁺ can react further to Fe²⁺ and I₂ according to Equation 2.

It is known that this stability problem can be overcome by encapsulating the iron and/or the iodine source to create a physical barrier between the iron source and the iodine source. In that way the iron and the iodine cannot react, preventing the two substances from evaporating or degrading.

Another major problem in the production of iron-fortified salt compositions is how to prevent segregation. It was found that to be able to produce a salt composition with homogeneously spread iron particles, a pre-treatment of the iron particles, such as agglomeration, is often needed in order to obtain particles having approximately the same particle size and weight distribution as the sodium chloride.

M. B. Zimmermann et al. in Am. J. Clin. Nutr., Vol. 77, 425-432, for example, disclose DFS which is fortified at a concentration of 1 mg iron per gram of salt with micro-encapsulated ferrous sulfate and with the iodine added as reagent-grade potassium iodide at a concentration of 25 μg iodide per gram of salt. The micro-encapsulated ferrous sulfate is prepared by encapsulation with partially hydrogenated vegetable oil using fluidized bed coating. The final product contains 50% ferrous sulfate.

A further double-fortified salt composition is disclosed in Canadian Chemical News (ACCN), June 2003, pages 14-17, which contains 1,000 ppm of iron in the form of ferrous fumarate and dextrin-encapsulated KI prepared by spray-drying. Since ferrous fumarate is dark brown, its particles have the appearance of an impurity in the salt. Hence, the iron fumarate was coated with stearine containing titanium dioxide, a typical food-grade white pigment. Furthermore, the iron fumarate was agglomerated before addition to the salt.

CA 02238925 discloses a stable DFS formulation comprising a salt and an iodine source being either potassium iodide or potassium iodate which is encapsulated in a digestible matrix and an iron source which is either encapsulated or not encapsulated. The iron source is ferrous fumarate, ferrous sulfate, metallic iron, or ferrous citrate. The encapsulation of the iodine source and, optionally, the iron source is achieved by spray-drying, coating in a fluidized bed, coating in a conventional rotary drum, coacervation, etc.

These prior art methods to prepare double-fortified salt all include one or more encapsulation steps in order to be able to maintain an acceptable iodine stability and colour of the salt composition. In addition, some methods comprise an agglomeration procedure. The need for these encapsulation and, optionally, agglomeration steps, however, makes the production of double-fortified salt compositions laborious and the DFS compositions themselves relatively expensive.

R. Wegmüller et al. in Journal of Food Science, 2003, Vol. 68, No. 2, 2129-2135 (“Dual fortification of salt with iodine and encapsulated iron compounds: Stability and acceptability testing in Morocco and Côte d'Ivoire”) disclose int. al. a double-fortified salt premix comprising non-encapsulated ferric pyrophosphate, and KI or KIO₃.

However, we have observed that the use of non-encapsulated ferric pyrophosphate in combination with KI or KIO₃ will result in double-fortified salt compositions of insufficient homogeneity if the compositions are handled. Furthermore, ferric pyrophosphate has a relatively low bioavailability, i.e. only 30% of ferrous sulfate. In order to increase its bioavailability, the ferric pyrophosphate can be micronized, thereby increasing its specific surface. However, in that case during handling segregation will occur as a result of different particle densities and particle sizes—i.e. percolation and heap segregation—and of wind sift effect during free fall. Moreover, air borne dust of pure ferric pyrophosphate will be formed, of which a large part is respirable, causing the risk of human inhalation and human exposure.

It is an object of the present invention to provide a double-fortified salt composition that does not have the above-mentioned drawbacks. Hence, it is an object of the present invention to provide a stable, homogeneous, double-fortified salt composition which can be prepared in a less laborious and thus economically more attractive way compared to the conventional DFS preparation methods and which remains homogeneous if stored for longer periods of time (at least 2 months).

It has now surprisingly been found that by selecting a particular iron source, selecting iodate as the iodine source, and by adding one or more food-grade oils, a stable and homogeneous premix for double-fortified salt is prepared via a one-step process wherein the components are simply mixed together. With the improved process according to the present invention encapsulation and agglomeration of the iron and the iodine source are not required.

Through mixing of the thus prepared premix with locally produced salt, surprisingly, a stable double-fortified salt composition is obtained which has good stability in time, is free-flowing, has an acceptable appearance, and is homogeneous. A further advantage of the process according to the present invention is that dust generation in handling of the DFS salt and segregation are prevented.

It is noted that by the term “stable” is meant that when properly packed, the premix and the double-fortified salt composition according to the present invention have a shelf life of at least 6 months, i.e. the period of time during which the premix and the double-fortified salt composition according to the present invention can be stored under ambient conditions while not showing any noticeable changes in taste and while the IO₃⁻ content remains within the specification limits, is at least 6 months.

In more detail, the present invention relates to a double-fortified salt composition comprising sodium chloride, between 5 and 100 ppm of iodine in the form of iodate (IO₃⁻), between 50 and 10,000 ppm of iron as a food grade iron(III) compound, and between 0.005 and 0.2 wt %, based on the total weight of the salt composition, of a food-grade oil, with the proviso that essentially all iron and iodate is not micro-encapsulated.

It is noted that by the phrase “essentially all iron and iodate is not micro-encapsulated” is meant that not more than 3 wt %, more preferably not more than 1 wt %, and most preferably not more than 0.5 wt % of the combined amount of iron and iodate which is present in the double fortified salt composition is micro-encapsulated. By the term “micro-encapsulation” is meant a process of surrounding or enveloping one substance with another on a very small scale, such that the second substance will constitute a physical barrier between the first substance and its environment. Essentially all the iron(III) and iodate present in the compositions according to the present invention has not undergone such a process, and therefore, these iron(III) and iodate particles are not surrounded or enveloped by another substance. In short, “micro-encapsulation” is often denoted as “encapsulation”.

Further, it is noted that the phrase “between 5 and 100 ppm of iodine in the form of iodate (IO₃⁻)” means that between 5 and 100 ppm of I is present (with 10 ppm of I being equivalent to 16.9 ppm of KIO₃), with ppm being the amount of I in mg per kg of the total salt composition. The phrase “between 50 and 10,000 ppm of iron as a food grade iron(III) compound” means that the content of the food grade iron(III) compound is such that the amount, in ppm, of Fe which is present in the salt composition is in the range of 50 to 10,000 ppm, with ppm being the amount of Fe in mg per kg of the total salt composition.

Furthermore, the present invention relates to a premix for such a double-Fortified salt composition. The term premix denotes a concentrated salt composition that is mixed from at least the components sodium chloride, an iron(III) compound according to the invention, an iodate source according to the invention, and the food-grade oil according to the present invention before it is marketed, used, or mixed further. More particularly, said premix for preparing the double-fortified salt composition according to the present invention comprises sodium chloride, between 0 and 10,000 ppm of iodine in the form of iodate (IO₃⁻), between 5,000 and 500,000 ppm of iron in the form of a food-grade iron(III) compound, and between 0.5 and 10 wt %, based on the total weight of the premix, of a food-grade oil, with the proviso that essentially all iron and iodate is not micro-encapsulated. It is noted that the addition of an iodate source to the premix according to the present invention is optional and dependent on whether or not the salt source to be fortified is already iodated.

An advantage of preparing a premix according to the present invention is that there is a greater likelihood of ensuring the correct concentration and even distribution of the iron and the iodate in the DFS composition suitable for consumption. Furthermore, the concept of centralized production of the concentrated premix and shipping it to iron and iodine-deficient countries all over the world, where it can be easily blended with locally produced salt, gives great flexibility, low logistic costs, and much lower costs for double-fortified salt than comparable shipping of the double-fortified salt as such.

Iron compounds suitable for use in the premix and the double-fortified salt composition according to the present invention are iron(III) compounds which are food-grade, i.e. iron(III) compounds that qualify under government regulations for use in food products and have a bioavailability in humans of at least 5%, more preferably at least 30%, of the bioavailability of ferrous sulfate (Fe(II)SO₄). Most preferably, the iron(III) compound has at least the same bio-availability as ferrous sulfate (for bioavailability data of iron salts see R. F. Hurrell, The Mineral Fortification of Foods, Leatherhead Publishing 1999, ISBN No. 0905748328, Chapter 3). Preferably, the iron compound is selected from the group consisting of ferric ammonium citrate, ferric choline citrate, ferric saccharate, ferric glycerophosphate (Fe₂[C₃H₅—(OH)₂PO₄]₃.xH₂O), ferric sulfate (Fe₂[SO₄]₃.xH₂O), ferric citrate, ferric pyrophosphate (Fe₄(P₂O₇)₃.xH₂O), ferric orthophosphate (FePO₄.xH₂O), sodium iron pyrophosphate (Fe₄Na₈(P₂O₇)₅.xH₂O), sodium iron ethylene diamine tetraacetate (FeNa—C₁₀H₁₂N₂O₈.3H₂O), and mixtures thereof. Preferably, only one iron(III) compound is employed in the premix and the double-fortified salt composition according to the present invention, but mixtures of two or more suitable iron(III) compounds can also be employed. Most preferred is FeNaEDTA, because of its high bioavailability (up to 400% of the bioavailability of ferrous sulfate) and because FeNaEDTA does not have the unpleasant metallic taste encountered in most other bioavailable iron compounds.

In another embodiment, one or more of the above-mentioned iron(III) compounds, preferably other than FeNaEDTA, is used in combination with a calcium salt of ethylene diamine tetraacetic acid (Ca-EDTA, e.g. Dissolvine E-CA-10 ex Akzo Nobel N.V.), a disodium salt of ethylene diamine tetraacetic acid (Na₂EDTA, e.g. Dissolvine NA-2-P ex Akzo Nobel N.V.), or in combination with mixtures of calcium and disodium salts of ethylene diamine tetraacetic acid. Preferably, the molar ratio between the combined iron(III) compounds and the combined amount of Ca-EDTA and Na₂EDTA in the double fortified salt composition and premix is 4:1 to 1:1.

Of the above-mentioned iron(III) compounds ferric pyrophosphate is the least preferred, since it has a relatively low bioavailability as explained above.

The iron(III) compound is present in the double-fortified salt composition according to the invention in such an amount that at least 50 ppm of iron, preferably at least 100 ppm of iron, and most preferably at least 200 ppm of iron is present in the double-fortified salt composition. The iron(III) compound is present in the double-fortified salt composition in such an amount that at most 10,000 ppm of iron, preferably at most 5,000 ppm of iron, and most preferably at most 3,500 ppm of iron is present in the double-fortified salt composition.

Iodine is present in the double-fortified salt composition and premix according to the invention in the form of iodate (IO₃⁻). It is preferably added to the sodium chloride in the form of an alkali or alkaline earth salt of iodate (hereinafter also denoted as the iodate source). More preferably, it is present as KIO₃, Ca(IO₃)₂, or NaIO₃. Most preferably, KIO₃ is used as the iodate source.

The double-fortified salt composition according to the invention comprises at least 5 ppm of iodine in the form of IO₃⁻, preferably at least 15 ppm of iodine in the form of IO₃⁻, and most preferably at least 25 ppm of iodine in the form of IO₃⁻. The double-fortified salt composition comprises at most 100 ppm of iodine in the form of IO₃⁻, preferably at most 75 ppm of iodine in the form of IO₃⁻, and most preferably at most 50 ppm of iodine in the form of IO₃⁻.

It is noted that the term “sodium chloride source” as used throughout this document is meant to denominate all conventional sources of sodium chloride of which more than 94% by weight is NaCl on a dry matter basis (determined using ISO 2483 Sodium chloride for industrial use—Determination of the loss of mass at 110° C.). Preferably, such a sodium chloride source contains more than 97% by weight of NaCl. More preferably, the sodium chloride source contains more than 99% by weight of NaCl. The sodium chloride source may be rock salt, solar salt, salt obtained by steam evaporation of water from brine, and the like.

To keep the iron homogeneously spread through the premix and the double-fortified salt composition according to the present invention, in other words to prevent segregation, the iron(III) compound and the sodium chloride are “fixed” together with one or more food-grade oils. Oils suitable for use according to the present invention can be any oils which are food-grade, have a neutral taste, preferably no colour and smell, excellent stability, and a low water content, i.e. they preferably contain less than 1% by weight of water. Preferably, the food-grade oil is selected from the group consisting of palm oil, corn oil, sunflower oil, soy bean oil, medium chain triglycerides, and polyethylene glycol. More preferably, from a health point of view, the oil is an unsaturated food-grade oil.

Most preferably, polyethylene glycol or medium chain triglycerides of fractionated vegetable fatty acids, wherein “medium chain” preferably means C₇-C₂₅ alkyl groups (e.g. BergaBest MCT oil ex Sternchemie), are used, and even more preferably polyethylene glycol having a molecular weight in the range of 200-1,000 is used.

A particular advantage of using the food-grade oil according to the present invention to “fix” the sodium chloride and the iron together is that the exact molecular weight and size distribution of the iron(III) compound employed in the DFS composition is of marginal importance. Typically, if iron(III) compounds having an average particle size of between 0.1 and 1,000 μm, preferably between 10 and 500 μm, are employed, stable DFS compositions are made.

The double-fortified salt composition according to the invention comprises a food-grade oil in such an amount that it causes the iron(III) compound to adhere to the sodium chloride crystals. More particularly, it comprises at least 0.005% by weight of food-grade oil, based on the total weight of the double-fortified salt composition, preferably at least 0.01% by weight of food-grade oil, even more preferably at least 0.02% by weight of food-grade oil, and most preferably at least 0.03% by weight of food-grade oil. The double-fortified salt composition comprises at most 0.2% by weight of food-grade oil, based on the total weight of the double-fortified salt composition, preferably at most 0.15% by weight of food-grade oil, and most preferably at most 0.1% by weight of food-grade oil.

The double-fortified salt composition is a solid and it preferably comprises at least 70% by weight, more preferably, at least 80% by weight, and most preferably at least 90% by weight of sodium chloride, based on the total weight of the salt composition.

As described above, the premix according to the present invention is suitable for preparing the double-fortified salt composition according to the present invention. More particularly, if mixed with the required amount of sodium chloride, optionally already iodated, the double-fortified salt composition of the present invention is obtained. The iron(III) and/or iodate concentration in the premix is such that when blended with the salt to be fortified, the resulting DFS end product has iron(III) and iodate levels as presented above. It is noted that the salt that is to be blended with the premix may already contain some or all of the iodate needed. It further may already contain part of the iron(III) that is needed.

As the skilled person will recognize, the optimum amounts of iron(III), iodate, and food-grade oil in the premix are dependent on the composition of the sodium chloride source with which the premix is to be blended to form the double-fortified salt composition according to the present invention, and on the desired quality of the DFS end-product. However, with the directions given below, the skilled person will easily be able to select the optimum amounts. If the premix is to be blended with a salt source which does not yet contain iron or merely contains small amounts of iron, the iron(III) compound typically is present in the premix according to the present invention in such an amount that at least 5,000 ppm of iron, preferably at least 10,000 ppm of iron, and most preferably at least 20,000 ppm of iron is present in said premix. The iron compound typically is present in the premix in an amount such that at most 500,000 ppm of iron, preferably at most 300,000 ppm of iron, and most preferably at most 200,000 ppm or iron is present in said premix.

The iodate preferably is present in the premix according to the present invention in an amount of at least 1 ppb of iodine as IO₃⁻, preferably at least 10 ppb of iodine as IO₃⁻, and most preferably at least 1 ppm of iodine as IO₃⁻. If the premix is to be blended with a salt source which is not yet iodated or which merely comprises low amounts of iodate, the iodate source typically is present in the premix in an amount of at most 10,000 ppm of iodine in the form of IO₃⁻, preferably at most 9,000 ppm of iodine in the form of IO₃⁻, and most preferably at most 8,000 ppm of iodine in the form of IO₃⁻.

The premix according to the invention comprises at least 0.5% by weight of food-grade oil, based on the total weight of the premix, preferably at least 1% by weight of food-grade oil, even more preferably at least 2% by weight of food-grade oil, and most preferably at least 3% by weight of food-grade oil. The premix comprises at most 10% by weight of food-grade oil, based on the total weight of the double-fortified salt composition, preferably at most 8.5% by weight of food-grade oil, and most preferably at most 7% by weight of food-grade oil.

The premix is also a solid and it preferably comprises at least 40% by weight, more preferably at least 50% by weight, and most preferably at least 60% by weight of sodium chloride, based on the total weight of premix.

Further, the present invention relates to a process for the preparation of the premix according to the present invention. In said process, sodium chloride is mixed with the required amount of a food-grade iron(III) compound according to the present invention and a food-grade oil in such an amount that it causes the iron compound to adhere to the sodium chloride crystals (i.e. to “fix” the iron and sodium chloride together), which typically is between 0.5 and 10 wt %, based on the total weight of the premix. It is noted that the sequence of admixing the sodium chloride, the food-grade iron(III) compound, and the food-grade oil can be chosen freely. Preferably, however, the food-grade(III) compound is first added to the sodium chloride and dry-mixed, after which the food-grade oil is distributed over the sodium chloride/iron mixture. Optionally, a calcium and/or disodium salt of ethylene diamine tetraacetic acid is added as well, typical amounts being as described above.

Said sodium chloride may be sodium chloride which has been iodated with iodate in any conventional manner. However, a non-iodated sodium chloride source may be used to prepare the premix as well, but in that case the sodium chloride source is mixed with an iodate source according the present invention prior to being mixed with the iron(III) compound according to the present invention.

Preferably, the iron(III) compound is added to the sodium chloride source as dry matter. Typical amounts are as described above. Preferably, the iodate source is either added to the sodium chloride source as dry matter or it is wet-sprayed on the sodium chloride source to be fortified. Most preferably, it is added as dry matter. Typical amounts for the iodate source are also as described above.

Mixing of the components of the premix can take place either batch-wise or continuously using a conventional mixer. Mixing can also be done manually, in which case the process typically is a batch-wise process. Examples of suitable mixers are a ribbon blender, a plough share mixer or a mixing screw. Required mixing times for obtaining a homogeneous premix depend on the mixer used, but typically will vary from 1 to 10 minutes.

The premix and the double-fortified salt composition according to the present invention are preferably prepared and processed at ambient temperature and under dry conditions.

The double-fortified salt composition according to the invention can be prepared analogously to the process for preparing the premix, i.e. by dry-mixing sodium chloride, optionally iodated with iodate, with a food-grade iron(III) compound according to the present invention and a food-grade oil in an amount such that it causes the iron compound to adhere to the sodium chloride crystals (typically between 0.005 and 0.2 wt %, based on the total weight of the salt composition). Typical amounts for iron and iodate are as earlier described. Optionally, a calcium and/or disodium salt of ethylene diamine tetraacetic acid is added as well, typically amounts being as described above. Preferably, however, the double-fortified salt composition is prepared by dry-mixing a premix according to the invention with a sodium chloride source, optionally already comprising iodate, in a ratio of between 1:10 and 1:1,000 premix to sodium chloride, preferably of between 1:20 and 1:100 premix to sodium chloride source. As the skilled person will recognize, the optimum ratio of premix to sodium chloride source depends on the composition of the premix and of the sodium chloride source with which the premix is to be mixed to form the double-fortified salt composition according to the present invention. It is furthermore dependent on the desired quality of the end-product. However, with the directions given above, the skilled person will easily be able to select the optimum ratio.

It is also possible to execute the above-mentioned type of mixing manually. Most preferably, it is a batch-wise process.

It is also possible to add one or more additives selected from the group consisting of a colour masker, such as TiO₂, micro-ingredients such as Vitamin A and folic acid, and minerals such as zinc sulfates, zinc oxides, or zinc carbonates to the premix or to the double-fortified salt composition. Preferably, a stabilizer is not used in the premix or the DFS composition of the invention.

Preferably, the double-fortified salt composition according to the invention is used as table salt. The double-fortified salt composition may also be used in food processing applications such as the preparation of corn-based products, in soy sauce, in fish sauce, in curries, and in cooked rice-based meals.

The present invention is elucidated by means of the following non-limiting Examples.

### COMPARATIVE EXAMPLE 1 AND EXAMPLES 2-4

The physical appearance of a conventional premix comprising encapsulated Fe(II)-fumarate was compared to the physical appearance of several premixes according to the present invention by means of Scanning Electron Microscopy. The Fe(II)-fumarate-containing premix of Comparative Example 1 was produced via granulation of the iron compound, followed by coating with soy stearine in a fluid bed processor and mixing with iodized sodium chloride. The premix thus obtained comprised 150,000 ppm of iron (corresponding to 468,000 ppm of Fe(II)-fumarate).

The scanning electron microscope used was the Leo Gemini, equipped with an Oxford Instruments INCA energy dispersive X-ray spectroscopy system (EDX), enabling chemical analysis of the irradiated part. The lateral resolution of the SEM was in the order of nanometers. The lateral resolution obtained during chemical analysis (EDX) was in the order of a micron, which was also the depth from which the signal originated.

Images were obtained with a secondary electron detector (SE), which gave morphological information, as well as with a backscattered electron detector (QBSD), where contrast was dominated by the average atomic number of the irradiated area. In QBSD mode, the areas with a higher average atomic number are brighter than those with a lower average atomic number.

The premix of Example 2 comprised Indian salt ex Tamil Nadu Salt Corporation containing 40 ppm of iodine as KIO₃ (corresponding to 67 ppm of KIO₃), 40,000 ppm of iron as FeNaEDTA (corresponding to 300,000 ppm of FeNaEDTA, being Ferrazone®, ex Akzo Nobel N.V.), and 4 wt % of polyethylene glycol with a molecular weight of 200 g/mol (PEG, ex J. T. Baker).

The premix of Example 3 comprised prepared Kenyan salt ex Ken Salt Ltd. containing 53 ppm of iodine as KIO₃ (corresponding to 90 ppm of KIO₃), 40,000 ppm of iron as FeNaEDTA (corresponding to 300,000 ppm of Ferrazone®), and 4 wt % of PEG.

The premix of Example 4 comprised prepared Suprasel® Fine from Akzo Nobel Hengelo Salt, 40,000 ppm of iron as FeNaEDTA (corresponding to 300,000 ppm of Ferrazone®), 4 wt % of PEG, and 2,090 ppm of iodine as KIO₃ (corresponding to 3,500 ppm of KIO₃).

The premixes of Examples 2 and 3 were prepared by weighing 60 g of the iron sodium ethylene diamine tetraacetate (Fe(III)NaEDTA), sieved at a particle size of <315 μm with a Retsch type sieving machine, into a plastic bag of 1 litre, after which 132 g of Indian and Kenyan salt, respectively, were added. The premix of Example 4 was prepared by weighing 60 g of the FeNaEDTA, sieved at a particle size of <315 μm with a Retsch type sieving machine, into a plastic bag of 1 litre, after which 131.3 g of Suprasel® Fine were added. To each of these three premixes, 0.7 g of KIO₃ was added.

The components were mixed manually by shaking and tumbling for 3-5 minutes until visually homogeneous mixtures were obtained. Subsequently, 8 g of PEG were added drop-wise on the surface of the dry mixes, followed by vigorous manual mixing and kneading for 5 minutes. The premixes were yellowish-light brown in colour.

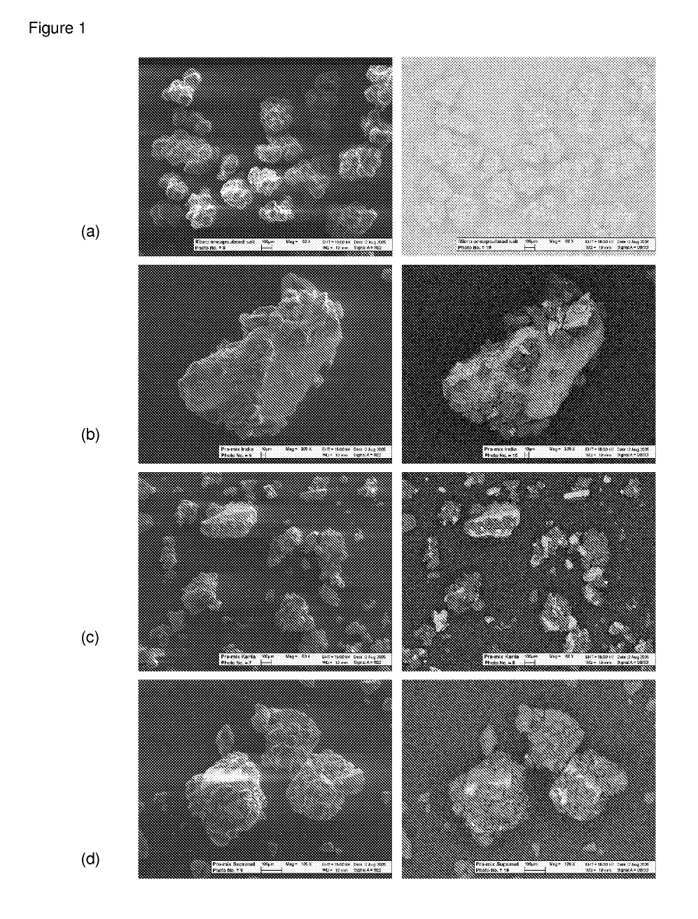

The physical appearance of the premixes of Comparative Example 1 and Examples 2, 3, and 4 was subsequently studied using Scanning Electron Microscopy. FIG. 1 shows the SEM pictures of the 4 premixes, with (a) showing SEM pictures of the premix of Comp. Ex. 1 from both the SE (left) and the QBSD (right) detector, (b) showing pictures of the premix of Ex. 2, (c) of the premix of Ex. 3, and (d) of the premix of Ex. 4.

From the pictures on the right side (i.e. the SEM pictures from the QBSD detector) it is clear that the premixes of Ex. 2-4 according to the present invention all consist of salt particles (light colour in the SEM picture) with small dark-coloured Ferrazone® particles attached to the salt surface and to each other. There is not much contrast in the picture of the premix of Comp. Ex. 1, indicating that the elements on the surface have a comparable atomic number, which is consistent with a structure of salt particles mixed with iron particles surrounded by a layer of stearine/TiO₂.

The pictures on the left side (i.e. the SEM pictures from the SE detector) give an impression of the 3-dimensional structure of the premix. In these pictures the light and dark areas are the result of well “lit” areas and shadows. The picture of the premix of Comp. Ex. 1 shows agglomerates of identical spheres, whereas the pictures of the premixes of Ex. 2-4 all show salt particles partly covered with Ferrazone® particles.

As demonstrated by these Examples, the premixes according to the present invention are different in physical appearance from conventional premixes wherein encapsulated iron compounds are present.

### EXAMPLES 5 AND 6

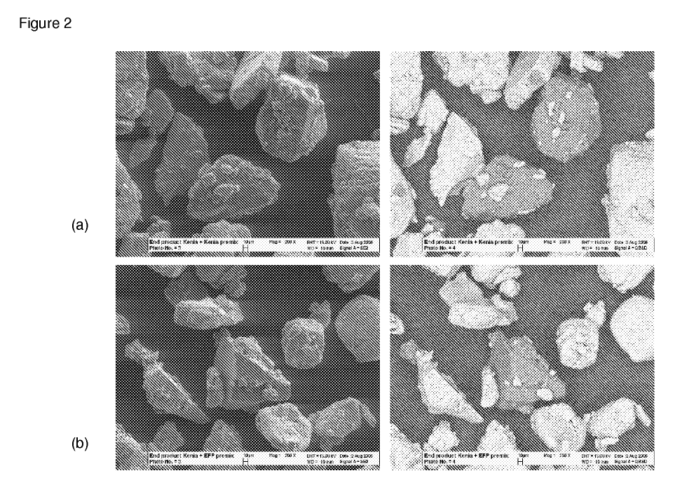

Double-fortified end products were prepared by manually mixing 10 g of the premixes of Example 3 and Example 4, respectively, with 990 g of refined iodized Kenyan table salt containing KIO₃ ex Ken Salt Ltd. until a visually homogeneous product was obtained. Subsequently, the physical appearance of both double-fortified end products was studied using Scanning Electron Microscopy. FIG. 2 shows the SEM pictures of the two end products, with (a) showing SEM pictures of the end product of Ex. 5 from the SE (left) and QBSD (right) detectors and (b) showing pictures of the end product of Ex. 6 from the SE (left) and QBSD (right) detectors.

To obtain the end product the premixes were diluted 100 times. As a result the Ferrazone® particles are more difficult to find. The dark-coloured Ferrazone® particles in the pictures on the right side (i.e. the SEM pictures from the QBSD detector) are all rather large and have smaller salt particles attached to the surface. The majority of the particles have a light colour indicative of NaCl. The bright white spots are caused by KIO₃ particles.

### EXAMPLE 7

In order to investigate the homogeneity of premixes and DFS end products, the premixes as set out in Table 1 and the DFS end products as set out in Table 2 were prepared. The following salt sources were used:
iodated Suprasel® Fine ex Akzo Nobel Salt bv
refined iodized Kenyan table salt containing KIO₃ ex Ken Salt Ltd.,
refined free-flowing iodized Indian Salt ex Tamil Nadu Salt Corporation Ltd.,
refined free-flowing iodized Nigerian kitchen salt ex Dangote Ind. Ltd.

TABLE 1

| | | Amount iron as | Amount |
|---|---|---|---|
| Premix | Salt type | Ferrazone ® (ppm) | PEG (wt %) |
| 7(a) | EFP salt | 53,300 | 0 |
| 7(b) | EFP salt | 53,300 | 1 |
| 7(c) | Kenyan salt | 40,000 | 4 |
| 7(d) | Indian salt | 40,000 | 4 |
| 7(e) | Nigerian salt | 40,000 | 4 |
| 7(f) | EFP salt | 40,000 | 4 |

The premixes 7(a)-(f) were prepared analogously to the preparation methods set out in Examples 2-4 using the amounts of Ferrazone® and PEG indicated in Table 1 (with 53,300 ppm of iron corresponding to 400,000 ppm of Ferrazone® and 40,000 ppm of iron corresponding to 300,000 ppm of Ferrazone®, respectively).

Double-fortified salt end products were prepared by manually mixing 10 g of the premixes 7(a)-(f) with 990 g of the salt indicated in the right column of Table 2 until a homogenous product was obtained (analogously to the preparation method described in Examples 5 and 6).

TABLE 2

| DFS End | | Mixed with Salt |
|---|---|---|
| product | Premix | source: |
| 7(G) | 7(a) | EFP salt |
| 7(H) | 7(b) | EFP salt |
| 7(I) | 7(c) | Kenyan salt |
| 7(J) | 7(d) | Indian salt |
| 7(K) | 7(e) | Nigerian salt |
| 7(L) | 7(f) | Kenyan salt |
| 7(M) | 7(f) | Indian |
| 7(N) | 7(f) | Nigerian salt |

Homogeneity measurements of the DFS end products 7(G)-(N) were conducted by determining the iron content in these salt compositions by measuring the iron intensity via XRF (X-Ray Fluorescence Spectroscopy). For this purpose, 7 randomly selected samples of 5 g each were taken from the DFS end products 7(G)-(N), which were subsequently subjected to an iron intensity measurement with XRF. The average standard deviation and the relative standard deviation (RSD) were determined as a function of the food-grade oil content.

No addition of a food-grade oil (end product 7(G)) resulted in visually inhomogeneous double-fortified salt compositions: confirmed by a RSD of the iron data of 32-47%. 1 wt % of food-grade oil in the premix already improved the RSD figures of the end product (DFS end product 7(H)) to 17-25%.

4 wt % of PEG in the premix gave the visually homogeneous double-fortified salts end products 7(I)-(N), which was confirmed by RSD values of the iron content ranging from 3-8%. The RSD values for the premixes 7(c)-(f) used for the preparation of end products 7(I)-(N) were less than 1.5%.

These experiments demonstrate that the content of food-grade oil in the end product largely determines the homogeneity of the end product.

### EXAMPLE 8

Three premixes 8(a)-(c) were prepared analogously to the preparation method described for the premixes of Examples 2-4, with the following compositions: Premix 8(a) was prepared from refined iodized Kenyan table salt containing KIO₃ ex Ken Salt Ltd., 40,000 ppm of iron as FeNaEDTA (corresponding to 300,000 ppm of Ferrazone®), and 4 wt % of PEG.

Premix 8(b) was prepared from refined free-flowing iodized Indian Salt ex Tamil Nadu Salt Corporation Ltd., 40,000 ppm of iron as FeNaEDTA (corresponding to 300,000 ppm of Ferrazone®), and 4 wt % of PEG.

Premix 8(c) was prepared from refined free-flowing iodized Nigerian kitchen salt ex Dangote Ind. Ltd., 40,000 ppm of iron as FeNaEDTA (corresponding to 300,000 ppm of Ferrazone®), and 4 wt % of PEG.

The corresponding double-fortified salt compositions 8(D), 8(E), and 8(F) were prepared by manually mixing 10 g of premixes 8(a), 8(b), and 8(c), respectively, with 990 g of Kenyan salt, Indian salt, and Nigerian salt, respectively, until a homogeneous product was obtained.

The thus obtained double-fortified salt compositions 8(D)-(F) containing 400 ppm of iron as FeNaEDTA (corresponding to 37000 ppm of Ferrazone®), iodine contents corresponding to the content of the Kenyan, Indian, and Nigerian salts, respectively, and 0.04 wt % of PEG were stored for 8 weeks in a 60-micron LDPE package at 30° C. and 90% RH (relative humidity). After 8 weeks none of the three compositions visually showed any deterioration in colour. Moreover, the iodine and iron contents remained constant over this period of time, as confirmed by conventional Flow Injection Analysis measurements and XRF measurements, respectively. Subsequent storage for an additional 10 months under the same conditions did not visually show any deterioration in colour either, while the iodine and iron contents also remained constant over that period of time.

### EXAMPLE 9

10 g of a premix prepared from 40,000 ppm of iron as FeNaEDTA (corresponding to 300,000 ppm of Ferrazone®), Nigerian salt ex Dangote Ind. Ltd comprising 48 ppm of iodine as KIO₃ (corresponding to 81 ppm of KIO₃), and 4 wt % of PEG were manually mixed with 990 g of Nigerian salt until a visually homogeneous product was obtained. The end product was slightly yellowish in colour.

To prepare an end product having the same visual appearance as the Nigerian salt forming the base of the DFS, TiO₂ was used as colour masking agent. For this purpose, a premix was prepared by first mixing Ferrazone® with TiO₂ in a weight ratio of 2:1, subsequently adding Nigerian salt and PEG in such amounts that a premix containing 40,000 ppm of iron as Ferrazone® (corresponding to 300,000 ppm of Ferrazone®) and 4 wt % of PEG was obtained. 10 g of this premix were then mixed with 990 g of Nigerian salt. The resulting end product, containing 400 ppm of iron, 0.04% PEG, 0.15 wt % of TiO₂, and 48 ppm of iodine as KIO₃ (corresponding to 81 ppm of KIO₃) showed a visual appearance similar to the Nigerian salt forming the base of the DFS. Homogeneity measurements showed no deteriorating effects due to addition of the TiO₂, as illustrated by the RSD values for iron and titanium. Fe 4% and Ti 5.9%.

1. A double-fortified salt composition comprising sodium chloride, between 5 and 100 ppm of iodine in the form of iodate, between 50 and 10,000 ppm of iron as a food-grade iron(III) compound, and between 0.005 and 0.2 wt %, based on the total weight of the salt composition, of one or more food-grade oils, wherein essentially all iron and iodate is not micro-encapsulated.

2. The double-fortified salt composition according to claim 1 wherein the food-grade iron(III) compound is selected from the group consisting of ferric ammonium citrate, ferric choline citrate, ferric saccharate, ferric glycerophosphate (Fe₂[C₃H₅—(OH)₂PO₄]₃.xH₂O), ferric sulfate (Fe₂[SO₄]₃.xH₂O), ferric citrate, ferric pyrophosphate (Fe₄(P₂O₇)₃.xH₂O), ferric orthophosphate (FePO₄.xH₂O), sodium iron pyrophosphate (Fe₄Na₈(P₂O₇)₅.xH₂O), sodium iron ethylene diamine tetraacetate (FeNa—C₁₀H₁₂N₂O₈.3H₂O), and mixtures thereof, and wherein the iodate is selected from the group consisting of KIO₃, Ca(IO₃)₂, and NabIO₃.

3. The double-fortified salt composition according to claim 2 further comprising a calcium and/or disodium salt of ethylene diamine tetraacetic acid.

4. The double-fortified salt composition according to claim 1 wherein the one or more food-grade oil is selected from the group consisting of palm oil, corn oil, sunflower oil, soy bean oil, medium chain triglycerides, and polyethylene glycol.

5. A premix for preparing the double-fortified salt composition according to claim 1, the premix comprising between 0 and 10,000 ppm of iodine in the form of iodate, between 5,000 and 500,000 ppm of iron as an iron(III) compound, and between 0.5 and 10 wt %, based on the total weight of the premix, of one or more food-grade oils, wherein essentially all iron and iodate is not micro-encapsulated.

6. The premix according to claim 5 wherein the iron(III) compound is selected from the group consisting of ferric ammonium citrate, ferric choline citrate, ferric saccharate, ferric glycerophosphate (Fe₂[C₃H₅—(OH)₂PO₄]₃.xH₂O), ferric sulfate (Fe₂[SO₄]₃.xH₂O), ferric citrate, ferric pyrophosphate (Fe₄(P₂O₇)₃.xH₂O), ferric orthophosphate (FePO₄.xH₂O), sodium iron pyrophosphate (Fe₄Na₈(P₂O₇)₅.xH₂O), sodium iron ethylene diamine tetraacetate (FeNa—C₁₀H₁₂N₂O₈.3H₂O), and mixtures thereof, wherein the iodate is selected from the group consisting of KIO₃, Ca(IO₃)₂, and NaIO₃, and wherein the one or more food-grade oil is selected from the group consisting of palm oil, corn oil, sunflower oil, soy bean oil, medium chain triglycerides, and polyethylene glycol.

7. The premix according to claim 6 further comprising a calcium and/or disodium salt of ethylene diamine tetraacetic acid.

8. A process for the preparation of a premix according to claim 5, the process comprising mixing a sodium chloride source with a food-grade iron(III) compound, and with one or more food-grade oils in such an amount that it causes the iron(III) compound to adhere to the sodium chloride crystals, wherein essentially all iron and iodate is not micro-encapsulated.

9. A process for the preparation of the double-fortified salt composition according to claim 1, the process comprising dry-mixing a premix with a sodium chloride source in a ratio of the premix to the sodium chloride source of 1:10 to 1:1,000, wherein the premix comprises between 0 and 10,000 ppm of iodine in the form of iodate, between 5,000 and 500,000 ppm of iron as an iron(III) compound, and between 0.5 and 10 wt %, based on the total weight of the premix, of one or more food-grade oils, wherein essentially all iron and iodate is not micro-encapsulated.

10. A process for the preparation of the double-fortified salt composition according to claim 1 wherein sodium chloride is mixed with an iodate source, a food-grade iron(III) compound, and one or more food-grade oils in such an amount that it causes the iron(III) compound to adhere to the sodium chloride crystals, and wherein essentially all iron and iodate is not micro-encapsulated.

11. A method for the preparation of a double-fortified salt end product suitable for consumption, the method comprising mixing the premix according to claim 5 with sodium chloride.

12. (canceled)

13. The double-fortified salt composition according to claim 3 wherein the molar ratio between the amount of food-grade iron(III) compound and the combined amount of calcium and disodium salt of ethylene diamine tetraacetic acid is 4:1 to 1:1.

14. The premix according to claim 7 wherein the molar ratio between the amount of iron(III) compound and the combined amount of calcium ethylene diamine tetraacetic acid and disodium ethylene diamine tetraacetic acid is 4:1 to 1:1.

15. The process according to claim 8, further comprising mixing the sodium chloride source with an iodate source.

16. The process according to claim 15, further comprising mixing the sodium chloride source with a calcium ethylene diamine tetraacetic acid and/or a disodium ethylene diamine tetraacetic acid.

17. The double-fortified salt composition according to claim 2 wherein the one or more food-grade oil is selected from the group consisting of palm oil, corn oil, sunflower oil, soy bean oil, medium chain triglycerides, and polyethylene glycol.

18. The double-fortified salt composition according to claim 3 wherein the one or more food-grade oil is selected from the group consisting of palm oil, corn oil, sunflower oil, soy bean oil medium chain triglycerides, and polyethylene glycol.

19. The process according to claim 9, wherein the iron(III) compound is selected from the group consisting of ferric ammonium citrate, ferric choline citrate, ferric saccharate, ferric glycerophosphate (Fe₂[C₃H₅—(OH)₂PO₄]₃.xH₂O), ferric sulfate (Fe₂[SO₄]₃.xH₂O), ferric citrate, ferric pyrophosphate (Fe₄(P₂O₇)₃.xH₂O), ferric orthophosphate (FePO₄.xH₂O), sodium iron pyrophosphate (Fe₄Na₈(P₂O₇)₅.xH₂O), sodium iron ethylene diamine tetraacetate (FeNa—CO₁₀H₁₂N₂O₈.3H₂O), and mixtures thereof, wherein the iodate is selected from the group consisting of KIO₃, Ca(IO₃)₂, and NaIO₃, and wherein the one or more food-grade oil is selected from the group consisting of palm oil, corn oil, sunflower oil, soy bean oil, medium chain triglycerides, and polyethylene glycol.

20. The process according to claim 19, wherein the premix further comprises a calcium and/or disodium salt of ethylene diamine tetraacetic acid.

21. The process according to claim 20, wherein the molar ratio between the amount of iron(III) compound and the combined amount of calcium ethylene diamine tetraacetic acid and disodium ethylene diamine tetraacetic acid is 4:1 to 1:1.
